(19) United States
(12) Patent Application Publication
(10) Pub. No.: US 2023/0245650 A1
(43) Pub. Date: Aug. 3, 2023

(54) USING CANONICAL UTTERANCES FOR TEXT OR VOICE COMMUNICATION

(71) Applicant: GOOGLE LLC, Mountain View, CA (US)

(72) Inventors: Daniel Cary, Campbell, CA (US); Erin Hoffman-John, Palo Alto, CA (US); Anna Kipnis, San Bruno, CA (US)

(21) Appl. No.: 18/009,488

(22) PCT Filed: Jun. 11, 2020
(86) PCT No.: PCT/US2020/037269

§ 371 Date: Dec. 9, 2022

(51) Int. Cl. G10L 15/18; G10L 15/183; G10L 25/54

(52) U.S. Cl. CPC G10L 15/1815; G10L 15/183; G10L 25/54; G10L 2015/088

(57) ABSTRACT

A memory stores information representing a set of canonical utterances. A processor receives information representing an utterance from a first user of an application and selects a canonical utterance from the set of canonical utterances based on semantic comparisons of the utterance from the first user and the set of canonical utterances. The semantic comparisons include semantic retrieval and semantic similarity operations that can be performed by a semantic natural language processing machine learning model. The processor presents the canonical utterance to a second user of the application instead of presenting the utterance from the first user. In some cases, the processor replaces the utterances from the user in a text stream or a voice chat with the canonical utterances in the set of canonical utterances.

### BACKGROUND

Text or voice chat allows users of an application (such as a video game) to communicate concurrently using the application. For example, multiple players can communicate using voice chat while they are playing the same video game. Although the text/voice chat functionality in applications is intended to facilitate communication, cooperation, and camaraderie, there is a downside: text/voice chat also allows users to make rude, demeaning, or abusive comments to each other. For example, a well-known issue in video gaming is the presence of toxic players who utilize text or voice chat channels to antagonize other players. Consequently, many applications do not implement text or voice chat and many users disable voice chat when it is offered. In cases where text or voice chat is implemented, the application provider is required to provide moderation tools that enable users to block or mute other users, as well as allowing users to report other users for abuse of the communication channels. Communication systems can also disrupt the immersive experience of the game, e.g., if the player's vocabulary or tone of the player's voice does not match the player's character. Text/voice chat is also limited to communication between players who speak the same language.

### SUMMARY

Filters are sometimes applied to “chat” communication systems to remove some types of comments before they are heard (or read) by other players. For example, the text streams generated by users can be monitored to detect profane or abusive comments, which are then filtered out before providing the text stream to other users. This approach is typically limited to monitoring text chats and cannot be easily implemented for voice chat systems because most automatic speech recognition models are unable to convert speech to text rapidly enough, and with high enough quality, to support effective filtering. Furthermore, toxicity filtering techniques produce false negatives that allow some toxic comments to pass through the filter and reach the other users. The total volume of toxic comments conveyed via the text or voice chat systems of a popular application, such as a popular online multiplayer video game, is so high that virtually all players of the video game will eventually be exposed to toxic language due to false negatives in the toxicity filter. This is unacceptable to family-oriented game developers, which inhibits the implementation of text or voice chat. Filtering is also largely ineffective in improving the immersive experience of the game because filtering focuses on removing comments and not changing the character of the comments.

The proposed solution in particular relates to a computer-implemented method comprising selecting, by at least one processor, a canonical utterance from a set of canonical utterances based on semantic comparisons of a representation of an utterance from a first user of an application and canonical utterances of the set of canonical utterances; and presenting the selected canonical utterance to a second user of the application instead of presenting the utterance from the first user of the application.

Generally, the utterance may comprise a text string and/or a vocal utterance from the first user of the application. In case of a vocal utterance the method may additionally comprise converting, by the at least one processor and using a speech-to-text application, the vocal utterance to a textual representation of the utterance from the first user which is to be compared with the canonical utterances of the set of canonical utterances.

In exemplary embodiments, selecting the canonical utterance from the set of canonical utterances is based on natural language processing (NLP). This may imply that selecting the canonical utterance from the set of canonical utterances comprises selecting the canonical utterance from the set of canonical utterances (a) using semantic retrieval of the canonical utterance from the set of canonical utterances based on the utterance or (b) using semantic similarity of the canonical utterance and the utterance received from the first user.

In an exemplary embodiment, selecting the canonical utterance from the set of canonical utterances comprises selecting the canonical utterance based on metadata associated with the set of canonical utterances. The metadata may for example indicate subsets of the set of canonical utterances. Metadata can for example be used to associate different vocal characteristics or pronunciations with a canonical utterance made by different characters. Selecting the canonical utterance from the set of canonical utterances may thus comprise identifying one of the subsets by comparing the metadata to at least one characteristic of the utterance received from the first user and selecting the canonical utterance from the identified one of the subsets. For example, a characteristic of the utterance may relate to at least one video game application parameter of a video game application played by the first and second users, such as a state of the video game application and/or a type of character the first user controls in the video game application.

In exemplary embodiments, the method may further comprise embedding the set of canonical utterances as a matrix having columns that include vectors representing the canonical utterances in the set. Generally, representing the utterances as vectors in a space having a predetermined number of dimensions is referred to herein as “embedding” the utterances. Using a matrix representing the set of canonical utterances may allow for selecting the canonical utterance from the set of canonical utterances by generating semantic similarity scores for the canonical utterances. Then, selecting the canonical utterance from the set of canonical utterances may also comprise selecting the canonical utterance associated with a semantic similarity score above a predetermined minimum threshold. In one embodiment, a default utterance may be selected in response to none of the semantic similarity scores being above the predetermined minimum threshold.

For replacing a user utterance by a canonical utterance that is selected from a set of canonical utterances, some embodiments embed the set of canonical utterances as a matrix having columns that include vectors representing the canonical utterances in the set. In other words, a set of canonical utterances may be stored in a matrix format for which each canonical utterance of the set has been converted in a vector containing merely numerical elements. For example, the vector representation of the user utterance can be embedded as a one-dimensional matrix, such as a 1, m-matrix, and thus as a vector, like Uᵤ=(a1, a2, a3, m). The numerical elements of such an embedded user utterance may be used for a comparison with the stored canonical utterance and thus a similarity assessment.

In an exemplary embodiment, an embedded matrix that represents the set of canonical utterances can be represented in a m, n-matrix having m lines and n columns. Accordingly, an exemplary embedded matrix Mₑ for the canonical utterances may be given by

$${M}_{e} = [ \begin{matrix}b 11 & b 12 & & b 1 n \\ b 21 & b 22 & … & b 2 n \\ b 31 & b 32 & & b 3 n \\ ⋮ & & ⋱ & ⋮ \\ bm 1 & bm 2 & … & bmn\end{matrix} ] .$$

For the comparison and thus the similarity assessment, semantic similarity scores may be generated for the canonical utterances by mathematically combining the numerical values of the embedded user utterance (such as Uᵤ) and the embedded matrix (such as Mₑ). Using the numerical elements of the vector and matrix representations allows for a fast comparison based on non-complex calculations and thus with modest computational load.

For example, semantic similarity scores for the canonical utterances may be generated by multiplying (elementwise) the elements of the vector representative of the utterance received from the user with the elements of each column in the embedded matrix (wherein each column includes the elements of a vector representing one of the canonical utterances). Thereby, similarity vectors may be calculated for a comparison of the embedded user utterance with the embedded canonical utterances. For example, similarity vectors for the above embedded vector U^{u} and the first two columns of the embedded matrix Mₑ may be calculated by:

S₁=(a1b11,a2b21,a3b31, . . . ambm1)

S₂=(a1b21,a2b22,a3b32, . . . ambm2)

These similarity vectors may then be used to produce semantic similarity scores for the canonical utterances. In one example, the semantic similarity scores for the canonical utterances in the set are equal to the magnitudes of the similarity vectors, such as similarity vectors S₁ and S₂. One or more of the canonical utterances that have a semantic similarity score above a minimum threshold may be then selected as candidates to replace a user utterance. For example, canonical utterance associated with the highest semantic similarity score can be selected to replace an analyzed user utterance. In one embodiment, if none of the semantic similarity scores for the canonical utterances are above the minimum threshold, a default utterance may be selected to replace the utterance. In some embodiments, other techniques for performing semantic matching or determining semantic similarity scores based on the embedded canonical utterance and user utterance are used.

The proposed solution also relates to a non-transitory computer readable medium embodying a set of executable instructions, wherein the set of executable instructions manipulate at least one processor to perform an embodiment of the proposed method.

The proposed solution also relates to a system comprising a memory configured to store a set of canonical utterances; and at least one processor configured to select a canonical utterance from the set of canonical utterances based on semantic comparisons of an utterance from a first user of an application and the canonical utterances of the set of canonical utterances, and present the selected canonical utterance to a second user of the application instead of presenting the utterance from the first user. An embodiment of the proposed systems may also be configured to perform an embodiment of the proposed method.

The present disclosure relates to techniques for translating comments in a text or voice chat into a canonical terminology and, in some cases, character-specific vocabularies or voice characteristics to remove toxicity and improve the sense of immersion in a video game. In some embodiments, an utterance (either text or voice) from a user is converted into/replayed by a canonical utterance that is selected from a set of canonical utterances using semantic retrieval or semantic similarity performed, e.g., by a natural language processing (NLP) machine learning (ML) model. The canonical utterance replaces the user utterance in the text or chat stream that is provided to other users, thereby ensuring that communication between the users is free of toxic language. Character-specific canonical utterances are also used in some cases to ensure that communication by a character is consistent with the nature or personality of the character. If voice chat is being used, the user utterance is captured by a microphone and a low latency speech recognition algorithm converts the user utterance from audio to text that is provided to the NLP ML model. The set of canonical utterances is generated and vetted to verify that the canonical utterances do not include toxic words or phrases such as profanity or abusive language. Metadata can be associated with the canonical utterances to indicate subsets, such as subsets of canonical utterances that are available to characters of different types. Metadata can also be used to associate different vocal characteristics or pronunciations with the canonical utterances made by different characters. In some embodiments, the set of canonical utterances are associated with translations of the canonical utterances into one or more other languages to facilitate communication between users that speak different languages.

The NLP ML model generates scores that indicate the semantic similarity of the user utterance to the canonical utterances (or a subset thereof indicated by metadata). As outlined above, in some embodiments, the canonical utterances are represented as vectors in a space having a predetermined number of dimensions, which is referred to herein as “embedding” the canonical utterances. In some embodiments, embedding the set of canonical utterances produces a matrix that includes the vector representations of each of the canonical utterances in the set. The embedding matrix is stored for subsequent use by the NLP ML model. The user utterance is embedded to generate a vector representation of the user utterance. The NLP ML model then generates semantic similarity scores for each of the canonical utterances by multiplying the vector that represents the user utterance with corresponding columns in the embedding matrix that include the vectors that represent the canonical utterances. The scores are used to select the canonical utterance that replaces the user utterance in the text or chat stream. In some embodiments, a subset of the canonical utterances having scores above the threshold are provided to the user and the user selects one of the subsets that most accurately represents the user utterance. If none of the scores is above a minimum threshold that indicates a canonical utterance that is sufficiently similar to the user utterance, a default utterance replaces the user utterance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video game processing system that implements a canonical vocabulary for communication between players according to some embodiments.

FIG. 2 is a block diagram of a cloud-based system that implements a canonical vocabulary for communication between players according to some embodiments.

FIG. 3 is a block diagram of a network processing system that implements a canonical vocabulary for communication between users that are connected by a network according to some embodiments.

FIG. 4 is a block diagram of a network processing system that generates canonical utterances in voice chat using speech-to-text conversion according to some embodiments.

FIG. 5 is a block diagram including a canonical set of utterances according to some embodiments.

FIG. 6 is a flow diagram of a method of substituting canonical utterances for utterances received from users during text or voice chat according to some embodiments.

### DETAILED DESCRIPTION

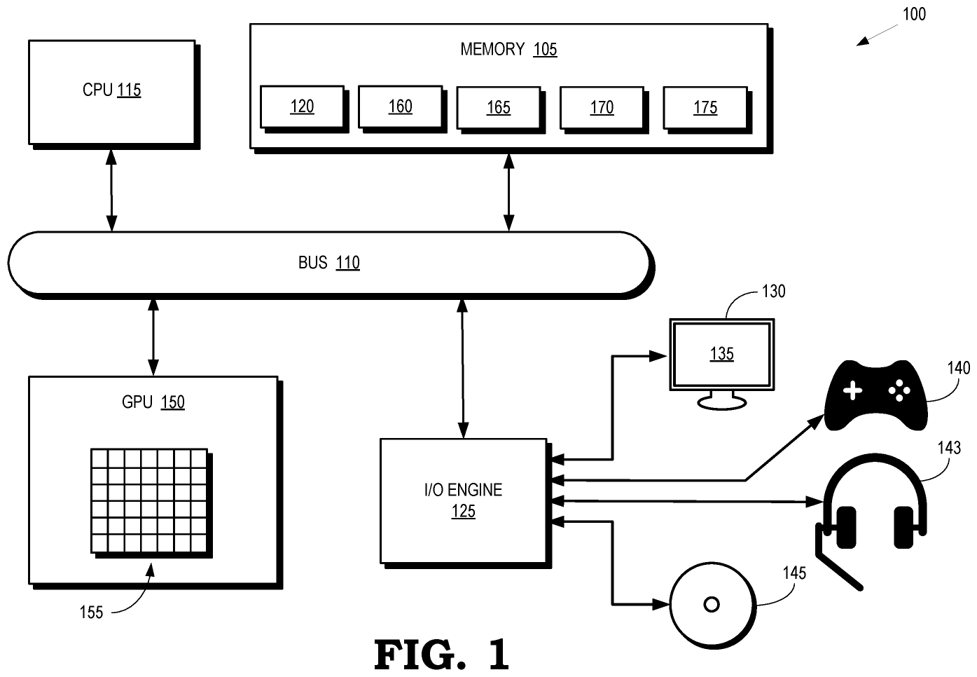

FIG. 1 is a block diagram of a video game processing system 100 that implements a canonical vocabulary for communication between players according to some embodiments. The processing system 100 includes or has access to a system memory 105 or other storage element that is implemented using a non-transitory computer readable medium such as a dynamic random-access memory (DRAM). However, some embodiments of the memory 105 are implemented using other types of memory including static RAM (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a central processing unit (CPU) 115. Some embodiments of the CPU 115 include multiple processing elements (not shown in FIG. 1 in the interest of clarity) that execute instructions concurrently or in parallel. The processing elements are referred to as processor cores, compute units, or using other terms. The CPU 115 is connected to the bus 110 and the CPU 115 communicates with the memory 105 via the bus 110. The CPU 115 executes instructions such as program code 120 stored in the memory 105 and the CPU 115 stores information in the memory 105 such as the results of the executed instructions. The CPU 115 is also able to initiate graphics processing by issuing draw calls.

An input/output (I/O) engine 125 handles input or output operations associated with a display 130 that presents images or video on a screen 135. In the illustrated embodiment, the I/O engine 125 is connected to a game controller 140 which provides control signals to the I/O engine 125 in response to a user pressing one or more buttons on the game controller 140 or interacting with the game controller 140 in other ways, e.g., using motions that are detected by an accelerometer. The I/O engine 125 also provides signals to the game controller 140 to trigger responses in the game controller 140 such as vibrations, illuminating lights, and the like. The I/O engine 125 is also connected to a headset 143 including a microphone that converts the player's voice into signals that are conveyed to the I/O engine 125 and audio signals received from the I/O engine 125 into sounds (such as the voice of another player) that are conveyed to the player wearing the headset 143. In the illustrated embodiment, the I/O engine 125 reads information stored on an external storage element 145, which is implemented using a non-transitory computer readable medium such as a compact disk (CD), a digital video disc (DVD), and the like. The I/O engine 125 also writes information to the external storage element 145, such as the results of processing by the CPU 115. Some embodiments of the I/O engine 125 are coupled to other elements of the processing system 100 such as keyboards, mice, printers, external disks, and the like. The I/O engine 125 is coupled to the bus 110 so that the I/O engine 125 communicates with the memory 105, the CPU 115, or other entities that are connected to the bus 110.

The processing system 100 includes a graphics processing unit (GPU) 150 that renders images for presentation on the screen 135 of the display 130, e.g., by controlling pixels that make up the screen 135. For example, the GPU 150 renders objects to produce values of pixels that are provided to the display 130, which uses the pixel values to display an image that represents the rendered objects. The GPU 150 includes one or more processing elements such as an array 155 of compute units that execute instructions concurrently or in parallel. Some embodiments of the GPU 150 are used for general purpose computing. In the illustrated embodiment, the GPU 150 communicates with the memory 105 (and other entities that are connected to the bus 110) over the bus 110. However, some embodiments of the GPU 150 communicate with the memory 105 over a direct connection or via other buses, bridges, switches, routers, and the like. The GPU 150 executes instructions stored in the memory 105 and the GPU 150 stores information in the memory 105 such as the results of the executed instructions. For example, the memory 105 stores instructions that represent a program code 160 that is to be executed by the GPU 150.

In the illustrated embodiment, the CPU 115 and the GPU 150 execute corresponding program code 120, 160 to implement a video game application. For example, user input received via the game controller 140 or the headset 143 is processed by the CPU 115 to modify a state of the video game application. The CPU 115 then transmits draw calls to instruct the GPU 150 to render images representative of a state of the video game application for display on the screen 135 of the display 130.

As discussed herein, the GPU 150 can also perform general-purpose computing related to the video game such as executing a physics engine or machine learning algorithm. The CPU 115 and the GPU 150 also support communication with other players (potentially using other computing systems) such as text or voice chat that is presented to the player via the display 130 (in text form) or the headset 143 (as audio).

The memory 105 stores information representing a set of canonical utterances 165 that are used to replace the text or voice chat communications generated by the player. The text or voice chat communications are referred to herein as the “utterances” of the player. The set of canonical utterances 165 includes canonical utterances that have been vetted to ensure that the canonical utterances are “family-friendly” and are expected to be inoffensive to substantially all people who read or hear the canonical utterances in the context of the game or other application. The set of canonical utterances 165 can include any number of canonical utterances, which only needs to be vetted once and then can be used indefinitely to replace the utterances of the player in the text or voice stream supported by the game or application. In some embodiments, the set of canonical utterances 165 includes metadata that defines various subsets of the canonical utterances, e.g., based on at least one video game application parameter, such as a state of the video game application and/or a type of character the first user controls in the video game application. The set of canonical utterances 165 can also include utterances in different languages to facilitate translation between players that speak different languages.

The CPU 115, the GPU 150, the array 155 of compute elements or other processor elements receive information representing an utterance from a user of an application (or a player of the game). The utterances received via the microphone of the headset 143 (in the case of voice chat), a keyboard (in the case of text chat), or other input device. Voice utterances received via the headset 143 are converted into text using a speech-to-text application, as discussed herein. The processor selects a canonical utterance from the set of canonical utterances 165 based on semantic comparisons of the utterance from the first user and the set of canonical utterances 165. The semantic comparisons include semantic retrieval and semantic similarity operations that can be performed by a semantic natural language processing machine learning model. The selected canonical utterance is then presented to a second user of the application instead of presenting the utterance from the first user. In some cases, the utterance from the user is replaced with the selected canonical utterance in a text stream or a voice chat.

Some embodiments of the CPU 115, the GPU 150, the array 155 of compute elements, or a combination thereof execute program code 170 that is used to perform NLP analysis such as semantic retrieval and semantic similarity. The semantic NLP ML algorithm is trained using a corpus of natural language data. Many text corpuses are available for training machine learning algorithms including corpuses related to media/product reviews, news articles, email/spam/newsgroup messages, tweets, dialogues, and the like. In the illustrated embodiment, the results of the NLP analysis are stored in a portion 175 of the memory 105, although this information or copies thereof are stored in other locations in some embodiments.

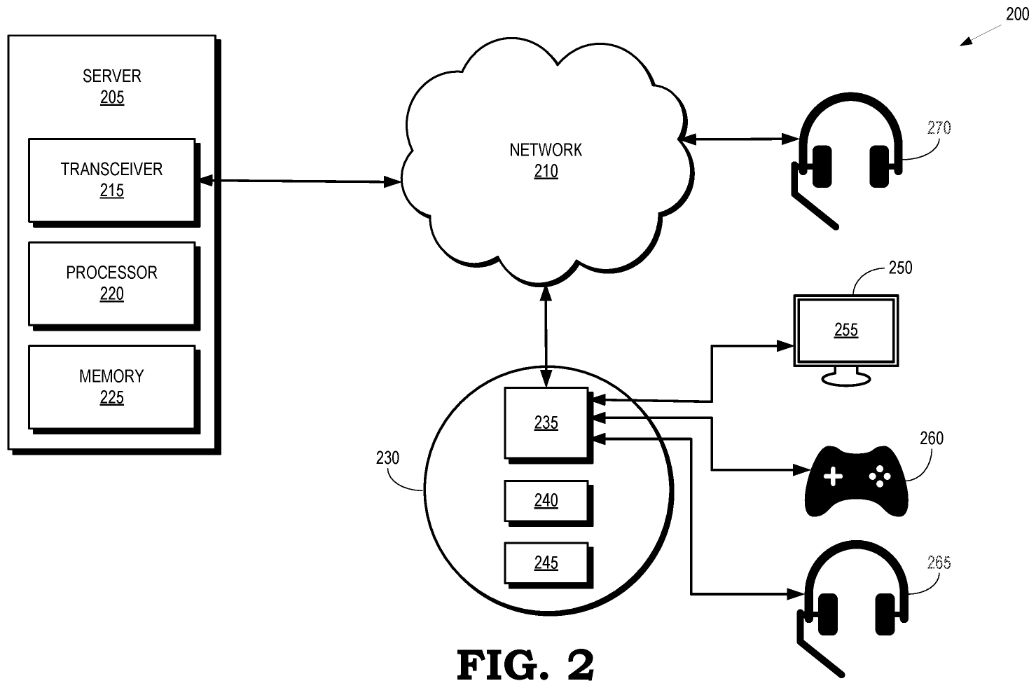

FIG. 2 is a block diagram of a cloud-based system 200 that implements a canonical vocabulary for communication between players according to some embodiments. The cloud-based system 200 includes a server 205 that is interconnected with a network 210. Although a single server 205 shown in FIG. 2, some embodiments of the cloud-based system 200 include more than one server connected to the network 210. In the illustrated embodiment, the server 205 includes a transceiver 215 that transmits signals towards the network 210 and receives signals from the network 210. The transceiver 215 can be implemented using one or more separate transmitters and receivers. The server 205 also includes one or more processors 220 and one or more memories 225. The processor 220 executes instructions such as program code stored in the memory 225 and the processor 220 stores information in the memory 225 such as the results of the executed instructions.

The cloud-based system 200 includes one or more processing devices 230 such as a computer, set-top box, gaming console, and the like that are connected to the server 205 via the network 210. In the illustrated embodiment, the processing device 230 includes a transceiver 235 that transmits signals towards the network 210 and receives signals from the network 210. The transceiver 235 can be implemented using one or more separate transmitters and receivers. The processing device 230 also includes one or more processors 240 and one or more memories 245. The processor 240 executes instructions such as program code stored in the memory 245 and the processor 240 stores information in the memory 245 such as the results of the executed instructions. The transceiver 235 is connected to a display 250 that displays images or video on a screen 255, a game controller 260, a headset 265, as well as other text or voice input devices. Some embodiments of the cloud-based system 200 are therefore used by cloud-based game streaming applications.

The processor 220, the processor 240, or a combination thereof execute program code to replace utterances received from a user of the application or player of the game with one or more canonical utterances from a set of canonical utterances. The division of work between the processor 220 in the server 205 and the processor 240 in the processing device 230 differs in different embodiments. For example, signals representative of the utterances received via the headset 265 can be conveyed to the server 205 via the transceivers 215, 235 and the processor 220 can identify a canonical utterance to substitute for the received utterance in a text or voice chat stream that is conveyed to a second user or player via a headset 270 that is connected to the network 210. For another example, the processor 240 identifies a canonical utterance that corresponds to an utterance received via the headset 265 and substitutes the canonical utterance for the received utterance in a stream that is provided to the server 205 for distribution to other users or players such as a user/player wearing the headset 270.

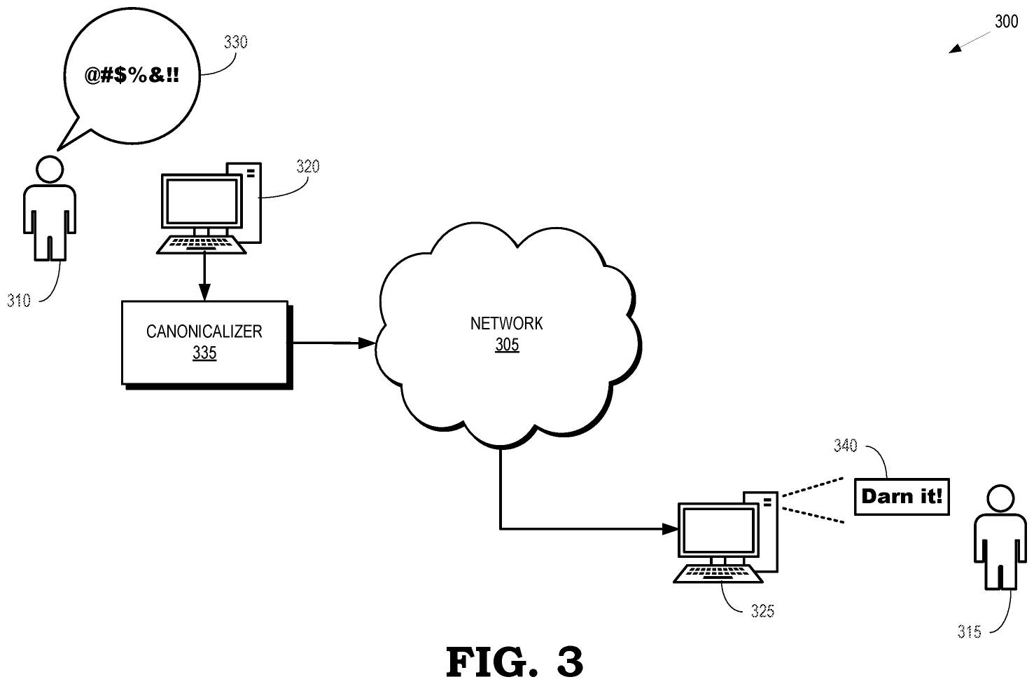

FIG. 3 is a block diagram of a network processing system 300 that implements a canonical vocabulary for communication between users that are connected by a network 305 according to some embodiments. Users 310, 315 of an application (such as players of a video game) are communicating via the network while using instances of the application executing on corresponding processing systems 320, 325 that are connected to the network 305. The processing systems 320, 325 are implemented using some embodiments of the processing system 100 shown in FIG. 1 or the cloud-based system 200 shown in FIG. 2.

The processing system 320 receives a stream including information representing an utterance 330 from the user 310. In some embodiments, the utterance 330 is a toxic text or voice chat comment received from the user 310. The utterance 330 is processed by a canonicalizer 335 that replaces information representing the utterance 330 in the stream with information representing a canonical utterance that is selected from a set of canonical utterances. Some embodiments of the canonicalizer 335 embed the set of canonical utterances as a matrix having columns that include vectors that represent the canonical utterances in the set. In other words, the canonicalizer 335 comprises a memory in which a set of canonical utterances is stored in a matrix format for which each canonical utterance of the set has been converted in a vector with merely numerical elements. A corresponding conversion can be implemented by NLP.

The canonicalizer 335 also generates a vector (for example in the form of a 1, n matrix) representation of the (actual) utterance 330 to create an embedded user utterance for comparison with the canonical utterances of the set. For example, the vector representation of the user utterance can be:

Uᵤ=(0.0,0.1,0.9, . . . ,0.0)

The numerical elements of such an embedded user utterance may be used for a comparison with the stored canonical utterance and to generate a similarity assessment. In some embodiments, the embedded matrix that represents the set of canonical utterances is represented as:

$${M}_{e} = \begin{matrix}0. & 0. & & 0.5 \\ 0.2 & 0.1 & … & 0. \\ 0.8 & 0.1 & & 0. \\ ⋮ & & ⋱ & ⋮ \\ 0. & 0.8 & … & 0.\end{matrix}$$

For the comparison and thus the similarity assessment the canonicalizer 335 generates semantic similarity scores for the canonical utterances by mathematically combining the numerical values of the embedded user utterance (such as Uᵤ) and the embedded matrix Mₑ. Using the numerical elements of the vector and matrix representations allows for a fast comparison based on non-complex calculations and thus with modest computational load.

For example, the canonicalizer 335 generates semantic similarity scores for the canonical utterances by multiplying (elementwise) the elements of the vector representative of the utterance 330 received from the user 310 with the elements of each column in the matrix (wherein each column includes the elements of a vector representing one of the canonical utterances). Thereby, similarity vectors are calculated for a comparison of the embedded user utterance with the embedded canonical utterances. For example, similarity vectors for the above embedded vector and the first two columns of the embedded matrix are:

S₁=(0.0,0.02,0.72, . . . ,0.0)

S₂=(0.0,0.01,0.09, . . . ,0.0)

These similarity vectors may then be used to produce semantic similarity scores for the canonical utterances. In one example, the semantic similarity scores for the canonical utterances in the set are equal to the magnitudes of the similarity vectors, such as similarity vectors S₁ and S₂.

One or more of the canonical utterances that have a semantic similarity score above a minimum threshold are selected as candidates to replace the utterance 330. For example, canonical utterance associated with the highest semantic similarity score can be selected to replace the utterance 330. If none of the semantic similarity scores for the canonical utterances are above the minimum threshold, a default utterance is selected to replace the utterance 330. Although operations performed on the vector and matrix representations disclosed herein are used to generate semantic similarity scores in the illustrated embodiment, other embodiments use other similarity measures to compare the user utterances to the canonical utterances and select canonical utterances to represent the user utterances.

The canonical utterance 340 is selected to replace the utterance 330 in the stream that is presented to the user 315. In some embodiments, the scores are used to decide whether the system should prompt the original player to confirm that the meaning of the canonical utterance 340 matches their original intent. The player can also be prompted to select the canonical utterance 340 from a list of probable options. For example, if the player says “Bad guy over your shoulder,” the canonicalizer 335 may find the following matches along with their similarity scores.

Option 1: “Enemy behind you!” Score=0.7

Option 2: “Watch out! Enemy over there!” Score=0.6

Option 3: “Friendly behind you!” Score=0.1

The player is presented with the two scores that are above a predetermined threshold (in this example the threshold is 0.5 and the player is presented with Option 1 and Option 2) and prompted to select which one is correct. If the score is high enough, the system transmits the canonical utterance 340 without additional player input. Scores can optionally be normalized to represent probabilities.

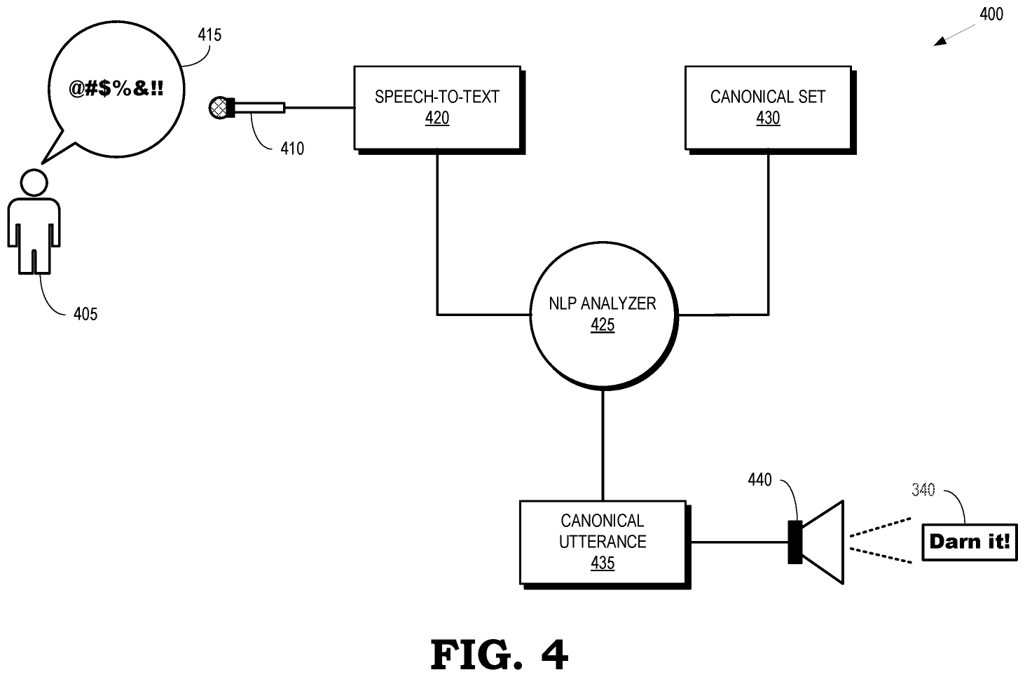

FIG. 4 is a block diagram of a network processing system 400 that generates canonical utterances in voice chat using speech-to-text conversion according to some embodiments. The processing system 400 is implemented using some embodiments of the processing system 100 shown in FIG. 1 or the cloud-based system 200 shown in FIG. 2. In the illustrated embodiment, a user 405 is using a voice chat application, which can be a standalone application or part of another application such as a game that is played with one or more other users. The user 405 speaks into a microphone 410 and the spoken words are captured as an utterance 415.

All the utterances that are captured by the microphone 410, including the utterance 415, are provided to a speech-to-text module 420 that is implemented using software, firmware, hardware, or a combination thereof. The speech-to-text module 420 generates a text representation of the utterance 415 and provides the text representation to a natural language processing (NLP) analyzer 425. Some embodiments of the speech-to-text module 420 implement a local speech recognition module or utilize a remote transcription service, e.g., the speech-to-text module 420 transmits an audio snippet representing the utterance 415 to the remote transcription service, which returns the text representation of the utterance 415.

A canonical set 430 including a previously vetted set of canonical utterances is accessible to the NLP analyzer 425. The NLP analyzer 425 compares the text representation of the utterance 415 to the canonical utterances in the canonical set 430. One or more of the canonical utterances are selected to represent the utterance 415. Some embodiments of the NLP analyzer 425 implement ML techniques for selecting a canonical utterance to represent the utterance 415. For example, the NLP analyzer 425 can implement semantic retrieval to select the canonical utterance from the canonical set 430 based on the text representation of the utterance 415. For another example, the NLP analyzer 425 can select the canonical utterance from the canonical set 430 based on semantic similarity of the canonical utterance and the utterance 415.

The canonical utterance 435 that is selected from the canonical set 430 is provided to a speaker 440, such as a speaker implemented in the headset 143 shown in FIG. 1 or the headset 265 shown in FIG. 2. The signals provided to the speaker 440 include signals representative of text that is converted to audio by the speaker 440 or signals representative of audio that is generated by the speaker 440. In some embodiments, the canonical utterance 435 is given an identification number that is provided to the speaker or other entity for generating the text or audio representation of the canonical utterance 435. An audio version 445 of the canonical utterance 435 is generated by the speaker 440 based on the signal representative of the canonical utterance 435.

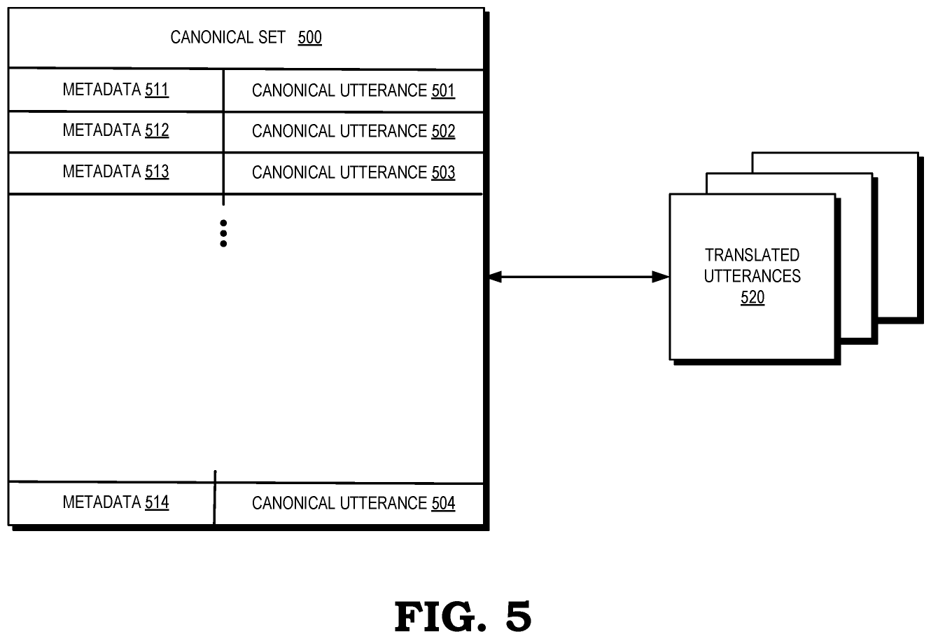

FIG. 5 is a block diagram including a canonical set 500 of utterances according to some embodiments. The canonical set 500 represents some embodiments of the set of canonical utterances 165 shown in FIG. 1 and the canonical set 430 shown in FIG. 2. The canonical set 500 includes the canonical utterances 501, 502, 503, 504, which are collectively referred to herein as “the canonical utterances 501-504.” The canonical utterances 501-504 include stored words or phrases that are used to facilitate communication between users of an application such as players of a video game. The canonical utterances 501-504 are vetted to determine their suitability for their intended audiences, e.g., the canonical utterances 501-504 are vetted to make sure that they are “family-friendly.” As discussed herein, the canonical utterances 501-504 replace the utterances received from the users or players in text streams or voice chat streams. In some embodiments, every utterance received from a user or a player is replaced by a corresponding canonical utterance 501-504 to ensure that all communication between the users or players is represented as one of the previously vetted canonical utterances 501-504.

In the illustrated embodiment, metadata 511, 512, 513, 514 (collectively referred to herein as “the metadata 511-514”) is associated with the canonical utterances 501-504. The metadata 511-514 indicates properties, characteristics, or subsets of the canonical utterances 501-504. For example, the metadata 511, 512 can indicate that the corresponding canonical utterances 501, 502 are associated with a first character type (such as an old wizard) and the metadata 513, 514 can indicate that the corresponding canonical utterances 503, 504 are associated with a second character type (such as a young hobbit). Canonical utterances 501-504 are selected to replace utterances received from users based on the metadata 511-514. For example, the canonical utterances 501, 502 are used to replace utterances received from players that are role-playing as an old wizard and the canonical utterances 503, 504 are used to replace utterances received from players that are role-playing as a young hobbit.

In the illustrated embodiment, the canonical set 500 is associated with (or includes) translations of utterances between an original language and one or more other languages, which are represented as the translated utterances 520. The canonical utterances 501-504 are translated ahead of time to generate lookup tables including the translated utterances 520. Translation of the canonical utterances 501-504 selected to replace a user utterance can therefore be performed nearly instantaneously in response to selection of one of the canonical utterances 501-504 as a replacement for a user or player utterance. The canonical set 500 of family friendly utterances is translated either through machine translation or human translation. The translated utterances 520 can be stored at either the original user's location (for translation of the canonical utterances 501-504 prior to transmission to another user) or at a recipient's location (for translation of the canonical utterances 501-504 after reception by the recipient user). In some embodiments, an identifier of a selected canonical utterance 501-504 is transmitted to the recipient user and the recipient uses the identifier to lookup the appropriate translation in the set of translated utterances 520.

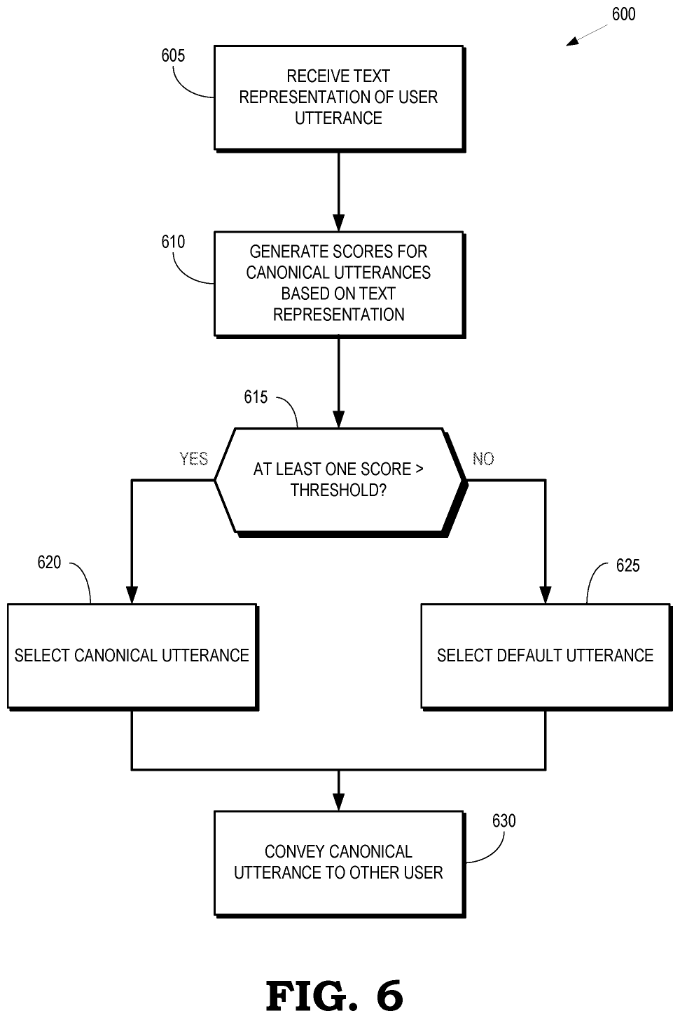

FIG. 6 is a flow diagram of a method 600 of substituting canonical utterances for utterances received from users during text or voice chat according to some embodiments. The method 600 is implemented in some embodiments of the processing system 100 shown in FIG. 1, the cloud-based system 200 shown in FIG. 2, the network processing system 300 shown in FIG. 3, and the network processing system 400 shown in FIG. 4.

At block 605, a processing system (or canonicalizer) receives a text representation of the user utterance. In some embodiments, the user's utterance is captured by a microphone and then provided to a speech-to-text module that generates the text representation of the user utterance, e.g., as shown in FIG. 4.

At block 610, the processing system generates scores for the canonical utterances based on the text representation of the user's utterance. In some embodiments, a semantic NLP ML algorithm generates the scores using semantic retrieval or semantic similarity of the user's utterance and one or more of the canonical utterances.

At decision block 615, the processing system determines whether one or more of the scores are above a threshold that represents a minimum threshold for substituting the canonical utterance for the user's utterance. If so, the method 600 flows to the block 620. If none of the scores for the canonical utterances is above the minimum threshold, indicating a mismatch between the users utterance and the canonical utterances in the canonical set, the method 600 flows to the block 625.

At the block 620, one or more of the canonical utterances that have scores above the threshold are selected to replace the user's utterance. For example, the canonical utterance having the highest score can be selected to replace the user's utterance. For another example, multiple canonical utterances having scores above the threshold can be presented to the user to select the canonical utterance that most closely matches the meaning that the user is intending to convey. Although presenting possible canonical utterances to the user decreases the speed of communication, the increase in the accuracy of the meaning of the communication can make the trade-off worthwhile. In some embodiments, the canonical utterances are selected from a subset of the canonical set, such as a subset that is indicated by metadata associated with the canonical utterances. For example, canonical utterances that have scores above the threshold and are associated (by metadata) with the same character type as the character being role played by the user are selected to replace the user's utterance. The method 600 then flows to block 630.

At block 625, the processing system has determined that none of the canonical utterances in the set are sufficiently similar to the user's utterance. Thus, the processing system chooses a default utterance to substitute for the user's utterance. The method 600 then flows to block 630.

At block 630, the canonical utterance is conveyed to one or more other users. As discussed herein, the canonical utterance is conveyed to the other users as text, voice, or other audio that represents the canonical utterance.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device are not required, and that one or more further activities are performed, or elements included, in addition to those described in some embodiments. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter can be modified and practiced in different but equivalent manners apparent to those skilled in the art having the benefit of the teachings herein. No limitations are intended to the details of construction or design herein shown, other than as described in the claims below. It is therefore evident that the embodiments disclosed above can be altered or modified and all such variations are considered within the scope of the disclosed subject matter. Accordingly, the protection sought herein is as set forth in the claims below.

1. A computer-implemented method comprising:
selecting, by at least one processor, a canonical utterance from a set of canonical utterances based on semantic comparisons of a representation of an utterance from a first user of an application and canonical utterances of the set of canonical utterances; and
presenting the selected canonical utterance to a second user of the application instead of presenting the utterance from the first user.

2. The method of claim 1, wherein the utterance comprises a text string from the first user of the application.

3. (canceled)

4. The method of claim 1, wherein:
the utterance comprises a vocal utterance from the first user of the application; and
the method further comprises:
converting, by the at least one processor and using a speech-to-text application, the vocal utterance to a textual representation of the utterance from the first user which is to be compared with the canonical utterances of the set of canonical utterances.

5. The method of claim 1, wherein selecting the canonical utterance from the set of canonical utterances is based on natural language processing.

6. The method of claim 5, wherein selecting the canonical utterance from the set of canonical utterances comprises selecting the canonical utterance from the set of canonical utterances using semantic retrieval of the canonical utterance from the set of canonical utterances based on the utterance or using semantic similarity of the canonical utterance and the utterance received from the first user.

7. (canceled)

8. The method of claim 1, wherein selecting the canonical utterance from the set of canonical utterances comprises selecting the canonical utterance based on metadata associated with the set of canonical utterances, and wherein the metadata indicates subsets of the set of canonical utterances.

9. The method of claim 8, wherein selecting the canonical utterance from the set of canonical utterances comprises identifying one of the subsets by comparing the metadata to at least one characteristic of the utterance received from the first user and selecting the canonical utterance from the identified one of the subsets.

10. The method of claim 1, further comprising:
embedding the set of canonical utterances as a matrix having columns that include vectors representing the canonical utterances in the set; and
wherein selecting the canonical utterance from the set of canonical utterances comprises generating semantic similarity scores for the canonical utterances by multiplying elements of a vector representative of the utterance received from the first user with corresponding elements of columns in the matrix including the vectors representing the canonical utterances.

11. (canceled)

12. The method of claim 10, wherein selecting the canonical utterance from the set of canonical utterances comprises selecting the canonical utterance associated with a semantic similarity score above a predetermined minimum threshold.

13. The method of claim 12, wherein selecting the canonical utterance from the set of canonical utterances comprises selecting a default utterance in response to none of the semantic similarity scores being above the predetermined minimum threshold.

14. (canceled)

15. (canceled)

16. A system comprising:
a memory configured to store a set of canonical utterances; and
at least one processor configured to select a canonical utterance from the set of canonical utterances based on semantic comparisons of an utterance from a first user of an application and the canonical utterances of the set of canonical utterances, and present the selected canonical utterance to a second user of the application instead of presenting the utterance from the first user.

17. The system of claim 16, wherein the at least one processor is configured to receive a text string representing the utterance from the first user of the application.

18. The system of claim 16 or 17, wherein the utterance from the first user of the application comprises a vocal utterance and the at least one processor is configured to receive an audio stream representing the vocal utterance from the first user of the application.

19. The system of claim 18, wherein the at least one processor is configured to convert, using a speech-to-text application, the vocal utterance to the utterance from the first user of the application to be compared with the canonical utterances of the set of canonical utterances.

20. The system of claim 16, wherein the at least one processor is configured to select the canonical utterance from the set of canonical utterances based on natural language processing.

21. The system of claim 20, wherein the at least one processor is configured to select the canonical utterance from the set of canonical utterances using semantic retrieval of the canonical utterance from the set of canonical utterances based on the utterance or using semantic similarity of the canonical utterance and the utterance received from the first user of the application.

22. The system of claim 16, wherein the memory is configured to store metadata associated with the set of canonical utterances, and wherein the at least one processor is configured to select the canonical utterance based on the metadata.

23. The system of claim 22, wherein the metadata indicates subsets of the set of canonical utterances.

24. The system of claim 23, wherein the at least one processor is configured to identify one of the subsets by comparing the metadata to at least one characteristic of the utterance received from the first user and selecting the canonical utterance from the identified one of the subsets.

25. The system of claim 16, wherein the at least one processor is configured to embed the set of canonical utterances as a matrix having columns that include vectors that represent the canonical utterances in the set.

26. The system of claim 25, wherein the at least one processor is configured to generate semantic similarity scores for the canonical utterances by multiplying elements of a vector representative of the utterance received from the first user with corresponding elements of columns in the matrix including the vectors that represent the canonical utterances.

27. The system of claim 26, wherein the at least one processor is configured to select the canonical utterance associated with a semantic similarity score above a minimum threshold.

28. The system of claim 27, wherein the at least one processor is configured to select a default utterance in response to none of the semantic similarity scores being above the minimum threshold.
